(19) United States
(12) Patent Application Publication
(10) Pub. No.: US 2009/0159169 A1
(43) Pub. Date: Jun. 25, 2009

(54) Device for Fixing a Module on the Inner Wall of a Tire

(75) Inventors: Pierre Durif, Enval (FR); Xavier Paul, Chamalieres (FR); Patrick T. Hicks, Taylors, SC (US); Terry James Martin, Duncan, SC (US)

Correspondence Address: COHEN, PONTANI, LIEBERMAN & PAVANE LLP, 551 FIFTH AVENUE, SUITE 1210, NEW YORK, NY, 10176, US

(73) Assignee: Michelin Recherche et Technique S.A., Granges-Paccot (CH)

(21) Appl. No.: 12/296,210

(22) PCT Filed: Mar. 30, 2007
(86) PCT No.: PCT/EP2007/053107

§ 371 Date: Mar. 11, 2009

(30) Foreign Application Priority Data
Apr. 4, 2006 (FR) 0603075

(51) Int. Cl. B29C 73/10

(52) U.S. Cl. 152/367

(57) ABSTRACT

A device for fixing a module to the internal wall of a tire. This device includes a support secured to the tire and of a flexible strip, the support including means for fixing said strip, the ends of the strip having at least two independent means for attaching the module, and the strip having means for immobilizing the module.

The invention relates to a device for fixing a module to the inner wall of a tire and more specifically to a device for fixing an electronic module.

The use of electronic modules in tires may provide a multitude of applications consisting in acquiring, storing and/or transmitting information for the purpose of monitoring the use of the tire and especially providing information about the evolution in performance of the tire during its lifetime.

Such electronic modules may comprise passive components, such as identification or RFID chips, and/or active components which are connected to an autonomous power supply system, such as batteries or else an inductive coupling system. These electronic modules may be designed to exchange information with external modules, serving for example as a user interface, by means of radio waves, the carefully adjusted frequency and power of which are in accordance with specific transmission protocols. They may also be designed to store information, so as to be interrogated subsequently, for example for analyzing the wear of the tire. The electronic modules are generally placed inside flexible or rigid protective cases intended to preserve the electronic components from being subjected to shocks and from the ambient atmosphere in the tire, especially owing to the presence of a fluid, for example, anti-oxidation or anti-puncture purposes, and from its environment.

Such an electronic module may in particular be fixed to the inside of the cavity formed by the tire once this has been fitted onto the wheel. To do this, it may be placed on a large number of supports. Thus, it may be fixed to the valve, fixed to the rim, fixed or bonded to the inner wall of the tire or else incorporated into the components of the tire. The selection of one of these solutions depends on the nature of the tire, on the stresses that it may undergo, on the nature of the energy source for the electronic module, on the information that it is desired to monitor and on the desired accessibility in the case of maintenance. The invention relates to the case of an electronic module fixed to the internal wall of the tire.

When the electronic module is thus joined to the tire, the selected fixing mode must ensure that the module is held in position whatever the rotation speed and the usage conditions of the tire.

Fixing solutions meeting these requirements have already been described, for example in the publications EP 0 936 089, U.S. Pat. No. 6,255,940, U.S. Pat. No. 6,462,650 or WO 2005/044600, which describe systems for fixing a module to the inner wall of a tire. These devices are made up of a flexible support, one face of which serves for joining to the inner wall of the tire and the other face of which has fixing means that cooperate with the attachment means placed on the module.

Although not limited to this type of application, the invention will be more particularly described with reference to electronic modules having a thickness of 2 cm or greater and having a length base at least equal to 4 cm and a width at least equal to 2 cm, these being intended to be inserted into tires for a dumper-type vehicle having an axial width of greater than 37 inches.

In the case of this type of vehicle, especially intended for being used in mines or quarries for trans-porting loads, the dimensions of the tires associated with the loads that they support on rolling lead to deflections of the tires of around 30%. They may in particular undergo load increases in excess of 50% owing to dynamic overloads associated for example with braking in the case of loader-type vehicles or else, for example, with deformation of the paths on which dumper-type vehicles have to run.

The deflection of a tire is defined by the radial deformation of the tire, or a change in radial height, when said tire passes from an unloaded state to a statically loaded state under nominal load and pressure conditions.

It is expressed in the form of a relative deflection, defined by the ratio of this change in radial height of the tire to one half of the difference between the outside diameter of the tire and the maximum diameter of the rim measured on the gutter. The outside diameter of the tire is measured statically in an unloaded state under nominal pressure.

The tire is thus subjected to radial stresses in this zone. These stresses are combined with longitudinal stresses, in particular because of the deradialization of the tire in the zone of the contact area. The combination of these stresses results in particular in deformations of the tire walls.

These deformations combined for example with the electronic modules such as those mentioned above which have a relatively large thickness, require fixing means more suited to ensuring the longevity of the fixing. This is because the aforementioned devices have weaknesses, owing to the particularly high stresses associated with the type of module and with the type of tire.

The inventors were thus given the task of defining a device for fixing an electronic module that ensures the longevity of said fixing, including in the case of a module as described above having a thickness of at least 2 cm, this being fixed in a tire that may undergo deflections of around 30%.

This objective was achieved according to the invention by a device for fixing a module to the internal wall of a tire, said device consisting of a support secured to the tire and of a flexible strip, the support including means for fixing said strip, the ends of the strip having at least two independent means for attaching the module, and the strip having means for immobilizing the module.

It is apparent that the device thus described according to the invention is effective in keeping the module in its position including under the high stresses undergone when the tire is used. It seems in fact that the flexible nature of the strip, which makes it possible in particular to absorb certain stresses associated with an attachment by independent means, allowing the stresses due to the loading to be at least locally distributed, ensures longevity of the module fastening in the tire. It also appears that this type of fastening is particularly well suited to a relatively thick module, both from the standpoint of fitting it and of keeping it in place.

According to a preferred embodiment, the flexible strip is removable. This has an advantage in terms of production, since it is thus possible to prepare or produce the device in two steps: fitting of the support, which is secured to the tire, followed by fitting of the strip. Furthermore, this may also allow the strip to be replaced for any reason, the support being retained.

According to one advantageous embodiment of the invention, the means for fixing the strip to the support are obtained by two openings in the support, forming a passageway and allowing the strip to pass through it. This embodiment is particularly advantageous by dint of its constructional simplicity and its use. The openings in the support may, for example be made at the moment of manufacturing said support. When this is made of a polymeric material such as rubber, an insert is for example provided, during the crosslinking of or vulcanization of the rubber, to which insert the rubber does not adhere, said insert then being removed so as to reveal two openings forming said passageway.

Preferably, according to the invention, the means for attaching each of the ends of the flexible strip are means complementary to means provided on the module. Such an embodiment makes it possible in particular for the phase of attaching the module to be simplified.

Also preferably, the means for attaching each of the ends of the strip are openings. This preferred embodiment of the flexible strip allows one end of said strip to be attached to a protuberance of the module.

In one advantageous embodiment of the invention, the means for immobilizing the module are forces exerted by said strip.

According to a first embodiment, the forces exerted by said strip are elastic restoring forces. According to this embodiment, the immobilization of the module is achieved as soon as said module has been attached.

According to a second embodiment, the forces exerted by said strip are obtained by the thermal contraction of the strip. To do this, the strip is advantageously made of a suitable material and the strip is heated once the module has been attached.

A preferred constructional variant of the invention also provides for the support to be made of a polymeric material crosslinked on the tire. Also advantageously, the support is crosslinked simultaneously with the crosslinking, especially vulcanization, of the tire. According to this constructional variant of the invention, the manufacture of the tire having a support is carried out more rapidly and the fixing of the support is perfectly secured to the internal wall of the tire.

Also advantageously, the flexible strip is formed from a polymeric material. Advantageously, this material is not reinforced so as to ensure that it is flexible and that the immobilizing forces are in accordance with the invention.

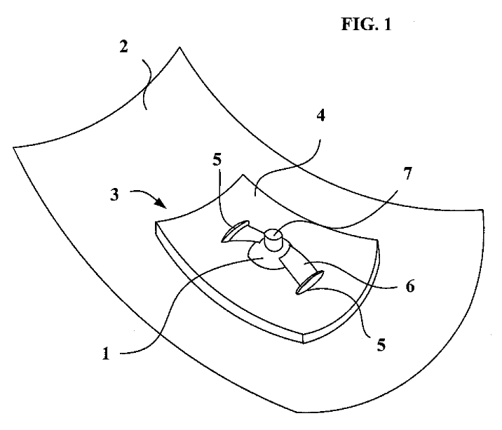

Other details and advantageous features of the invention will emerge from the following description of exemplary embodiments of the invention with reference to FIGS. 1 to 3 which show:

FIG. 1, a schematic representation of a device according to the invention;

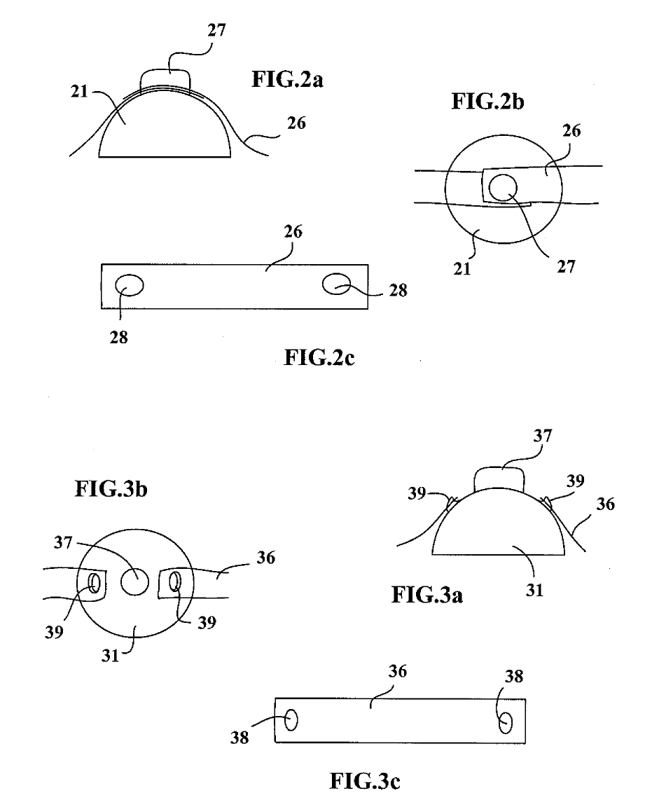

FIGS. 2a to 2c, a schematic representation according to a first embodiment of a device according to the invention; and

FIGS. 3a to 3c, a schematic representation according to a second embodiment of a device according to the invention.

The figures are not drawn to scale in order to make it easier to understand it.

FIG. 1 shows an electronic module 1 fixed to the internal wall 2 of a tire using a fixing device 3. The fixing device 3 is itself made up of a support 4 secured to the tire, said support being provided with two openings 5 through which a flexible strip 6 passes.

The support 4 may, for example, be produced when building the tire, one or more rubber layers constituting it being put into place and then cured simultaneously with the curing of the tire. The two openings 5 may be formed by the presence of an element put into place during curing. Such an element is made of any material known to those skilled in the art to which rubber does not adhere, which element is inserted between two rubber layers and the ends of which are positioned so as to obtain the desired two openings.

According to another embodiment, the support 4 may be made of rubber by prior molding and attached to the tire before the latter is cured. The support 4 is then cured and the bonding obtained by interposing an interface between the support 4 and the tire, enabling bonding to be achieved between support and tire while the latter is being cured.

According to a final embodiment, the support 4 may be made of rubber by prior molding by only undergoing partial curing which makes it possible to preserve the base; that is to say the part of the support that is intended to come into contact with the tire, which part is non-crosslinked. The support thus obtained is placed on the tire before the latter is cured and the bond between support and tire is thus obtained during the curing of the tire. According to this embodiment, however, it is prudent to limit the preservation times of prefabricated and partially crosslinked supports.

The support 4 is advantageously made of unreinforced rubber in order to support all the tire deformations more effectively. If, however, the presence of reinforcing elements is required, the latter are advantageously elastic reinforcing elements.

The flexible strip 6 is also made of unreinforced rubber and has, at each of its ends, means for attaching the electronic module 1. The flexible strip 6 is manufactured independently and added when fitting the electronic module 1. Said strip is slid in via one of the openings 5, emerging via the other opening so that the upper part of the support 4 located between the two openings 5 forms a passageway that retains the flexible strip 6, forming a loop closed by the top of the electronic module 1.

The electronic module 1 has a measurement head 7, for example, for pressure measurement at its top. To ensure undisturbed measurements, it is preferable for the measurement head 7 not to be covered by the attachment means associated with the flexible strip 6. Since each of the ends of the flexible strip 6 has attachment means, it is possible to fix the module without covering the measurement head 7 of the electronic module 1.

FIGS. 2 and 3 illustrate two exemplary embodiments of the invention.

In FIGS. 2a and 2b, the electronic module 2a and the ends of the flexible strip 6 are shown in a side view and a top view respectively. Each of the ends of the strip 26 is secured to the module 21 by an attachment at the measurement head 27 without covering the latter. As shown in FIG. 2c, the ends of the strip 26 each have an opening 28 substantially of the size of the measurement head 27. In the case shown in FIG. 2, the measurement head is circular and the openings 28 are also circular and have a diameter substantially equivalent to that of the measurement head.

Tests have shown that such a device provides good attachment of the module. The strip 26 made of unreinforced rubber advantageously has elastic properties which, combined with the attachment system, are sufficient to immobilize the electronic module 21. Rolling tests have actually shown that, when the tire is subjected to large stresses due to deformation when passing over stony ground, the electronic module remains in place and the fixing device is undamaged.

According to this first constructional variant of the invention, the flexible strip 26 may optionally include zones covered with a material of the Velcro fabric type for attaching one end of the strip 26 to the other in the overlap zones of these two ends. This Velcro attachment may be found in particular on either side of the measurement head. This option has the advantage of not leaving one end free and thus better keeping it in place and preventing it from becoming detached from the measurement head 27 during deformation of the tire. It may also allow the distribution of the stresses exerted in order to immobilize the module 21. According to another option, the flexible strip 26 is made of a material of the Velcro fabric type for mutually attaching the ends in the overlap zones of these two ends.

FIGS. 3a, 3b and 3c show a constructional variant of a fixing device according to the invention designed to fix an electronic module 31 having appendages 39 for attaching the ends of the flexible strip 36 by means of the openings 38.

According to this constructional variant, tests have given results that are very similar to the previous case. This solution may have the advantage of never touching or even grazing the measurement head 37 when attaching the strip 36.

Tests were carried out on a tire of 40.00R57 size fitted onto a vehicle of the CAT 793 type in which a module of the pressure sensor type, the external dimensions of which were 9 cm in length, 5 cm in width and 3 cm in thickness, was fixed.

This module was fixed with a device as described in FIG. 2, the support being fixed to the internal wall of the tire during the manufacture thereof. Since the support was made of rubber, it was vulcanized simultaneously with the tire. The module is then fixed using a rubber strip, the two ends of which are attached to the measurement head. The ends are also fixed together by a Velcro fabric present on each end.

Rolling trials were carried out on a terrain having stones and ruts, reproducing the ground that the tires fitted to vehicles running in mines may encounter. The deflections observed during rolling could be up to 50% in dynamic overload.

The results obtained made it possible to confirm the effectiveness of the fixing device according to the invention in particular in terms of retention over the course of time when rolling.

1. A device for fixing a module to the internal wall of a tire, comprising a support secured to the tire, and a flexible strip, wherein the support includes means for fixing said strip, wherein the ends of the strip have at least two independent means for attaching the module, and wherein the strip has means for immobilizing the module.

2. The fixing device according to claim 1, wherein the flexible strip is removable.

3. The fixing device according to claim 1, wherein the means for fixing the strip to the support are obtained by two openings in the support, allowing the strip to pass through them.

4. The fixing device according to claim 1, wherein the means for attaching each of the ends of the strip are means complementary to means provided on the module.

5. The fixing device according to claim 4, wherein the means for attaching each of the ends of the strip are openings.

6. The fixing device according to claim 1, wherein the means for immobilizing the module are forces exerted by said strip.

7. The fixing device according to claim 6, wherein the forces exerted by said strip are elastic restoring forces.

8. The fixing device according to claim 6, wherein the forces exerted by said strip are obtained by the thermal contraction of the strip.

9. The fixing device according to claim 1, wherein the support is made of a polymeric material crosslinked on the tire.

10. The fixing device according to claim 1, wherein the flexible strip is formed from a polymeric material.
